(19) United States
(12) Patent Application Publication
(10) Pub. No.: US 2018/0058132 A1
(43) Pub. Date: Mar. 1, 2018

(54) System, Method and Apparatus for a Portable Door Operation Module

(71) Applicant: Kristi Ann CLIFT, Coppell, TX (US)

(72) Inventor: Kristi Ann CLIFT, Coppell, TX (US)

(21) Appl. No.: 15/255,106

(22) Filed: Sep. 1, 2016

(51) Int. Cl. E05F 15/70; E05F 15/79; E05F 15/73; E05F 15/75; E05F 15/76; E05F 15/77

(52) U.S. Cl. CPC E05F 15/70; E05F 15/79; E05F 15/73; E05Y 2900/132; E05F 15/76; E05F 15/77; E05F 2015/763; E05F 15/75

(57) ABSTRACT

A door operation method, apparatus and system for a portable module for operating a door. The door operating method includes sensing a reason to at least one of open or close the door, processing the at least one of opening or the closing of the door based on the sensing, engaging a door operation mechanism, and at least one of opening or closing the door by the portable module, wherein the portable module is coupled the door.

### FIELD OF THE INVENTION

The disclosure relates to systems, apparatus and methods for a portable module for operating doors. In particular, the disclosure relates to a portable system, apparatus and method for detecting a need to open and/or close a door and operating the door accordingly, where such module may be coupled to any door.

### BACKGROUND OF THE INVENTION

There are many situations when one is incapable of operating a door, but is in need of opening a door or closing a door. Currently, there are sliding doors and doors that operate by pushing a handicap button to initiate such operation. However, such doors and devices are not easily portable to any door, such as a pre-existing door in a home or business. Thus, there is a need for a module that would be portable and may be coupled to any door, to where such door would be operated by the module without the need of a human to operate it manually.

### SUMMARY OF THE INVENTION

Embodiments described herein relate to a door operation method, apparatus and system for a portable module for operating a door. The door operating method includes sensing a reason to at least one of open or close the door, processing the at least one of opening or the closing of the door based on the sensing, engaging a door operation mechanism, and at least one of opening or closing the door by the portable module, wherein the portable module is coupled the door.

### BRIEF DESCRIPTION OF DRAWINGS

Reference will now be made to the following drawings:

FIG. 1 is an embodiment illustrating a flow diagram of a door operation method for operating a door;

FIG. 2 is a block diagram illustrating an embodiment of a portable apparatus for operating a door;

FIG. 3 is a block diagram illustrating an embodiment of a door operating system;

FIG. 4A-B are diagrams illustrating an embodiment using a portable apparatus for operating a door;

FIG. 5A-B are diagrams illustrating another embodiment using a portable apparatus for operating a door;

FIG. 6A-B are diagrams illustrating further embodiment using a portable apparatus for operating a door; and

FIG. 7A-D are diagrams illustrating door handle embodiments.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, markup languages, style sheets and JavaScript libraries, including but not limited to Windows Presentation Foundation (WPF), HTML/CSS, XAML, and JQuery, C, Basic, *Ada, Python, C++, C#, Pascal, *Arduino. Additionally, operations can be carried out using any variety of compiler available.

Aspects of the present disclosure are described herein with reference to flowchart illustrations and/or block diagrams of methods, systems and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

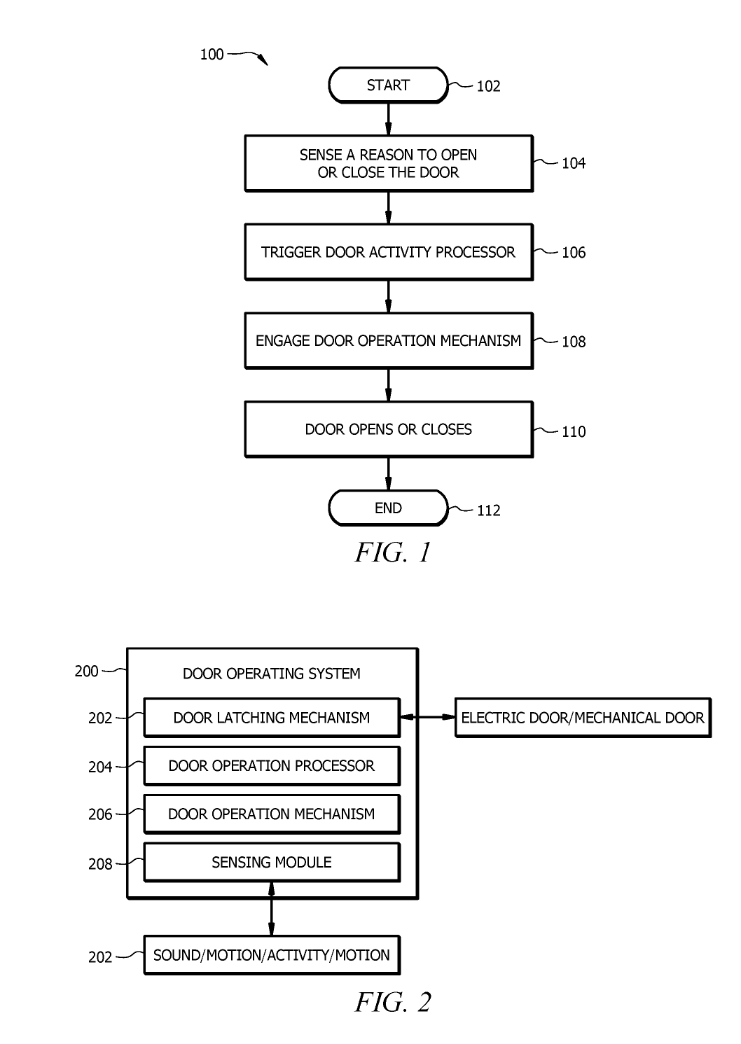

FIG. 1 is an embodiment illustrating a flow diagram of a door operation method 100 for operating a door. The method 100 starts at step 102 and proceeds to step 104. At step 104, the method 100 senses a reason to open or close the door. At step 106, the method 100 triggers a door activity processing based on the sensed activity. At step 108, the method 100 engages the door operation mechanism. At step 110, the method 100 causes the door to open or close. The method 100 ends at step 112.

In one embodiment, the method 100 senses the need to open the door and closing of the door is based on a timer. In such embodiment, the door sensor triggers a reason for opening the door, for example, a person within the sensor range, a sound requesting a door to open, data over a wireless connect (WIFI, Bluetooth, Near Field Communication (NFC), Internet/IP Connectivity, Field Display, fiber optics, multi-drop interface, radio frequency, satellite modems, and the like) etc. However, the closing of the door may be preset to a specific time lapse, passing/clearing of a person in the area, rather than sensing a person walking through and the sensing area being free. In other embodiments, the method 100 may be able to do both, sensing and time lapse.

FIG. 2 is a block diagram illustrating a portable apparatus 200 for operating a door. The door operating apparatus 200 has a latching mechanism 202, door operating processor 204, a door operating mechanism 206 and a sensing module 208.

The latching mechanism 202 is a coupling mechanism that couples the door operating apparatus 200 to a door, a door hinge, the ceiling, or to a wall. The latching mechanism 202 facilitate the portability of the door operating apparatus 200 and the ability to couple the door operating apparatus 200 to any door.

The door operation processor 204 receives input from the sensor module 208. The sensor module 208 detects an activity that requires a door operation. For example, the sensing module 208 may detect an object, person or sound that manifest into a request to open or close the door. Then, the door operation processor 204 receives such input and initiates such opening and/or closing of a door utilizing the door operation mechanism 206. The door operation mechanism 206 may compromise a mechanical mechanism that controls a door handle, may include a door handle that replaces a pre-existing door handle, or may operate a door via the hinges, where the hinges are placed on the sides, top or bottom of the door.

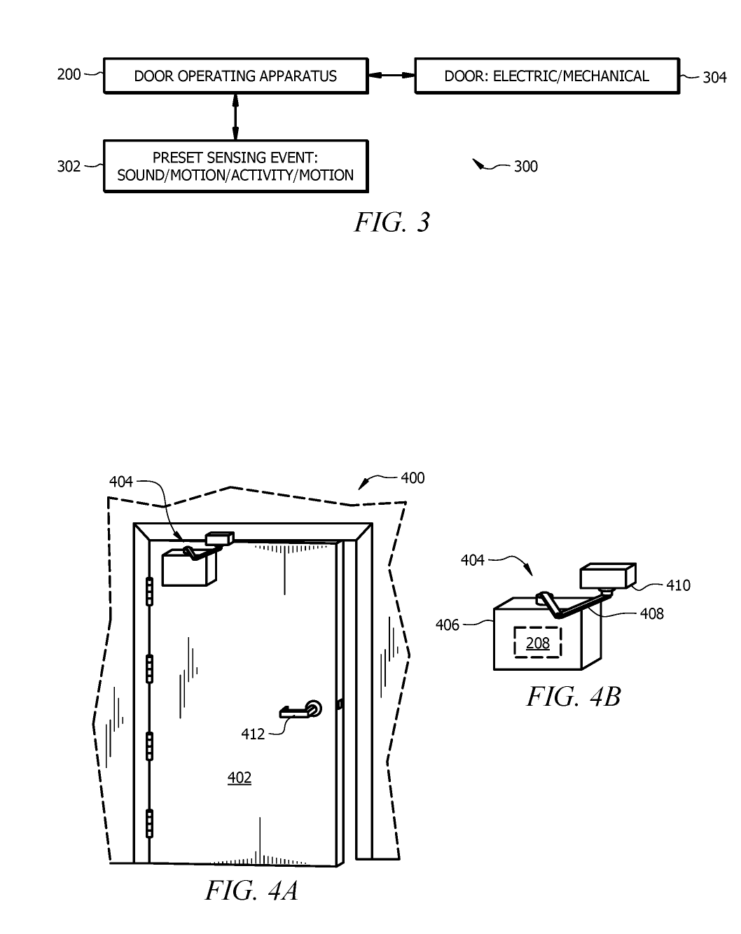

FIG. 3 is a block diagram illustrating an embodiment of a door operating system 300. The door operating system 300 includes a door operation apparatus 200, as described in FIG. 2, a pre-set sensing activity 302 and a door 304. The preset sensing activity 302 may include sensing a person, object, weight, sound, motion, activity/motion, facial recognition, iBeacon Technology, and the like. The door 304 is any type of door, such as, manual door, electronic door, manual door, French door, swinging door, rolling-up/down door, hydraulic door and the like.

The apparatus and system described herein may be used by small children (lined up and going through a door school setting, Church-Vacation Bible School, etc.), a person on crutches, a person using a wheel chair, mother with baby/child/stroller, person who is injured or in a not fully functional state, patients with IV, an Oxygen Tank patients, an elderly patient or any age person with no strength, a broken arm patients, a broken leg patients, a disabled/handicap person, a person using walkers, a person using a cane, a person with their hands full or not functional and the like.

In one embodiment, the sensor may be able to communicate with a device to cause door operation, such as a moving hospital bed, crutches, wheel chair, stroller and the like. In another embodiment, the sensing trigger may be portable and coupled to such devices or on any device.

The door operating apparatus may also operate utilizing one or more of the following: WIFI/Bluetooth/NFC/etc., Phone app, infrared laser, audible-voice, proximity, motion, touch, pressure, and maybe sense a person's presence with badge (like temporary hotel room keys).

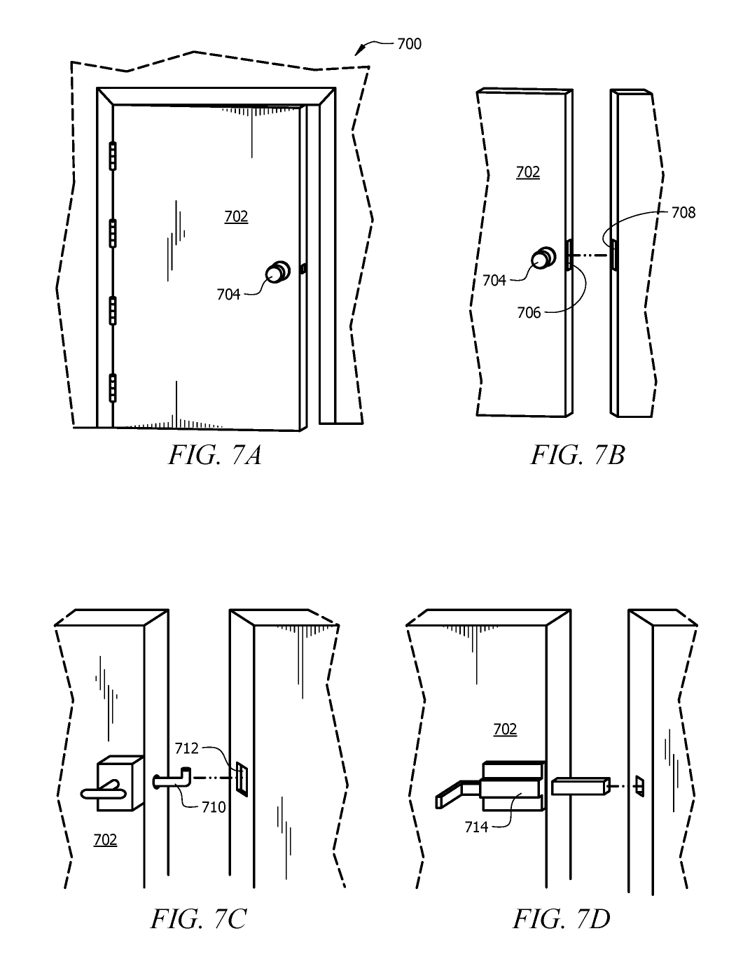

FIG. 4A-B are diagrams illustrating embodiment 400 using a portable apparatus for operating a door 404 for door 402, as shown in FIG. 4A. A handle 412 of the door 402 may be any type of handle, which is described in more detail in FIG. 7A-D. FIG. 4B illustrates the portable apparatus for operating a door 402, which includes box 406, arm 408 and edge latch 410. In this embodiment, the box 406 includes the door operating processor 204 to operate the door operation mechanism 206, as described in FIG. 2. The latching mechanism 202 of FIG. 2 may include the arm 408 and the edge latch 410. It may also include a handle mechanism that communicates with the box 406, where a door handle is operated by the door operation mechanism 206 and/or the door operation mechanism 204. The box 406 may include a sensing module 208, as described in FIG. 2, or may communicate with one of more sensing module 208 located remotely from the box.

In such an embodiment, the arm 408 is coupled to the box 406 and the door latch 410. The arm 408 stretches upon command to push against the door latch 410 and cause the door 402 to open/close. The box 406 may be coupled to the door, to the wall or ceiling adjacent to the door. If the box 406 is not coupled to the door 402, the door latch 410 is coupled to the door. If the box 406 is coupled to the door 402, the door latch 408 is coupled to an adjacent surface to facilitate the function of the arm 408 in opening the door 402.

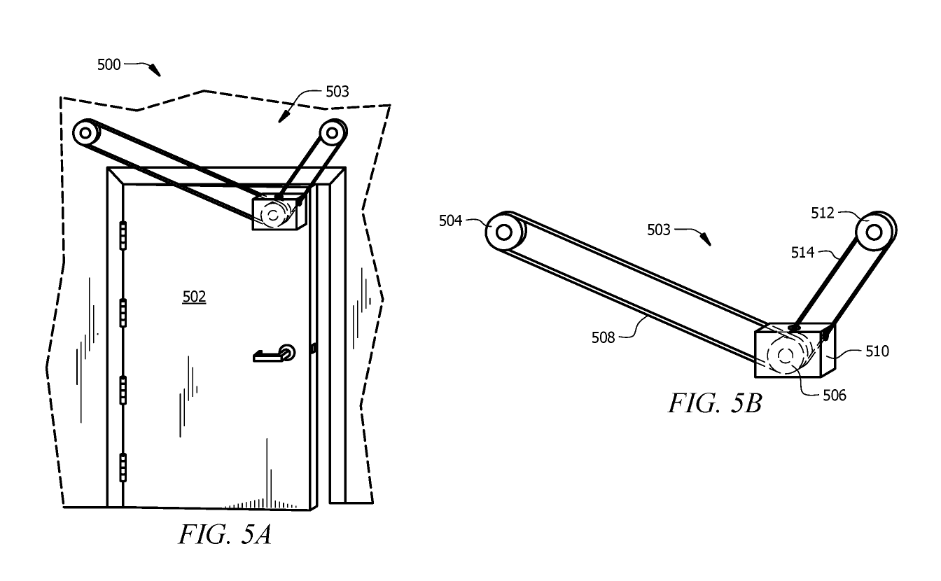

FIG. 5A-B are diagrams illustrating another embodiment 500 using a portable apparatus for operating a door 503 for door 502, as shown in FIG. 5A. FIG. 5B illustrates the portable apparatus for operating a door 502, which includes a first pulley 504, a second pulley 506, a connector 508, a box 510, a third pulley 512 and a second connector 514.

In such an embodiment, the pulleys are controlled by the box 510, where a pulley may be attached or detached from the box 510. In this embodiment, the second pulley 506 is operated by the door operation mechanism 206 and/or the door operation mechanism 204, of FIG. 2. The connector 508 may be a chain, wire, string, or the like. The second pulley 506 causes the connector 508 to be retracted by either the first pulley 504 or the second pulley 506 to cause the door 502 to open. Similarly, it may cause the second connector 514 to retract to third pulley 512 causing the door 502 to close. In this embodiment, the second pulley 506 is coupled to the door, the first pulley 504 to a surface that is adjacent to the door 502 when in open position and the third pulley 512 to a surface adjacent to the door 502 when in closed position. The box 510 may include a sensing module 208, as described in FIG. 2, or may communicate with one of more sensing module 208 located remotely from the box.

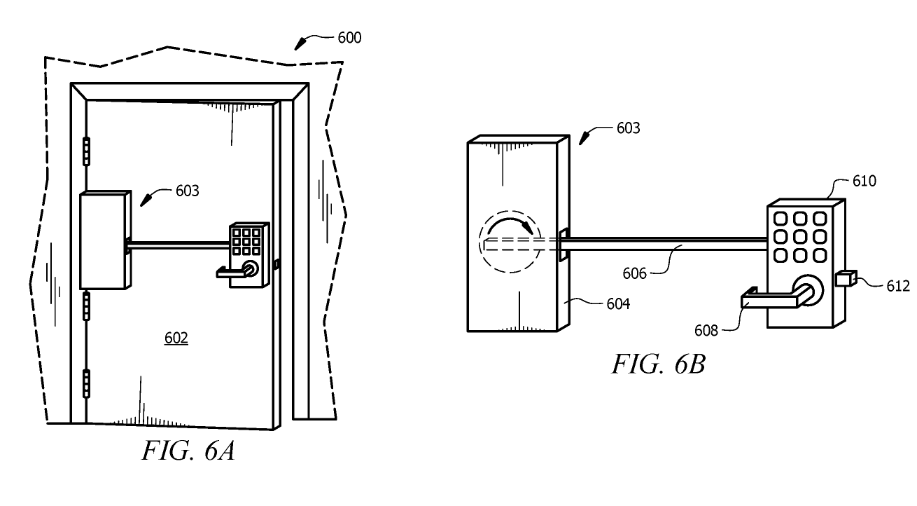

FIG. 6A-B are diagrams illustrating embodiment 600 using a portable apparatus for operating a door 603 for door 602, as shown in FIG. 6A. In FIG. 6B, the portable apparatus for operating a door 603 is shown to include box 604, arm 606, handle 608, key pad 610, and a widget 612. In this embodiment, the box 606 includes the door operating processor 204 and door operation mechanism 206, as described in FIG. 2. The box 604 is coupled to the arm 606, which functions in similar manner as described in FIG. 4, where the arm 606 causes the door 602 to open and/or close. The key pad 610 may be used to lock and unlock the door 602.

In other embodiments, the key pad 610 is not utilized in the box 604 to control the locking and unlocking of the door 602. The handle 608 may be coupled to the arm 606 or may be separate. The handle 608 may be any handle used in the market or may be an intelligent arm with functionalities as included in the box 604. The handle 608 and/or the key pad 610 control the widget 612, which is used to keep the door closed and/or to lock/unlock the door 602. In other embodiments, the key pad may be replaced with a card reader, a scanner, a magnetic card processor and the like. Embodiments of the handle 608 are described in FIG. 7A-D. The box 604 may include a sensing module 208, as described in FIG. 2, or may communicate with one of more sensing module 208 located remotely from the box.

FIG. 7A-D are diagrams illustrating handle 704 embodiments utilized with portable apparatus for operating a door 700, as shown in FIG. 7A. The handle 704 may be a round handle, push down handle, a latching handle, a magnetic handle, a hook controlling handle and the likes. FIG. 7B is an embodiment of a handle that utilizes a magnet 706, coupled to the door 702, and a magnet 708 coupled to an edge adjacent to the door 702 when it is in the closed position. The magnets 706 and 708 are activated to cause the door 702 to remain closed or locked and may be turned off to allow the door to be released and ready to be opened. In FIG. 7C a hook 710 is coupled to the handle and a hook latch is coupled and/or included to a surface adjacent to the door 702 when in closed position. The hook is shifted in position to cause the door to remain closed and/or locked or to be released and prepare the door 702 for opening. In FIG. 7D a hinge 714 shifts forward and backwards to allow the door 702 to remain in closed/locked position and to shift back to prepare the door 702 to be opened. These handles are examples illustrating different handles that may be utilized, however, any handle that can be controlled by a motor or a processor may be used. In other embodiments, the hinge may be at the top or the bottom of a door to allow the door to roll-up and down.

The embodiments described above may be combined to where more than one is used to operate a door. For example, an intelligent handle maybe combined with an arm type apparatus, as described in FIG. 2, with or without a key pad. In addition, the portable apparatus is utilized with any door to create an intelligent door that opens and closes upon command. Such a device may be used with any door that already exists in a home, without the need for a custom door.

It will be appreciated by those skilled in the art that changes could be made to the embodiments described above without departing from the broad inventive concept. It is understood, therefore, that this disclosure is not limited to the particular embodiments herein, but it is intended to cover modifications within the spirit and scope of the present disclosure as defined by the appended claims.

1. A door operation method for a portable module for operating a door, comprising:
sensing a reason to at least one of open or close the door;
processing the at least one of opening or the closing of the door based on the sensing;
engaging a door operation mechanism; and
at least one of opening or closing the door by the portable module, wherein the portable module is coupled the door.

2. The door operating method of claim 1, further comprising at least one of:
sensing that at least one object passed through the door and closing the door after such sensing;
sensing an area is clear of obstacles and closing the door;
reaching a time threshold and closing the door due to the time threshold;
sensing at least one of a decrease or increase in weight on an area and at least one of closing or opening the door accordingly, respectively;
recognizing a physical feature and at least one of closing or opening the door;
sensing a sound requesting at least one of closing or opening of the door and at least one of closing or opening the door accordingly, respectively;
sensing motion for at least one of opening or closing the door;
receiving data instructing for at least one of closing or opening of the door, and at least one of closing or opening the door accordingly, respectively, wherein the data is received via at least one of a wireless and wired connection, and wherein the data instruction is from at least one of a magnetic card, a keyless entry, a keypad, an application on a portable device, a device on a handicap equipment, oxygen tank, patient IV device, stroller, a device on a hospital equipment, wheel chair, a wearable device, a portable device and data over at least one WIFI, BlueTooth, New Field Communication, Internet, IP connectivity, fiber optics, radio frequency, multi-drop surface, and satellite modem.

3. The door operation method of claim 1, wherein the portable module is coupled to a pre-exiting door, without the need for a custom door.

4. The door operation method of claim 3, wherein the portable module is coupled to at least one of a handle of the door, one or more hinge of the door, a surface adjacent to the door, and on the door itself.

5. The door operation method of claim 4, wherein the hinges are position on at least one of the side of the door, top of the door of the bottom of the door.

6. The door operation method of claim 1, wherein the door is at least one manual door, electric, door, French door, swinging door, or roll up/down door.

7. The door operation method of claim 1, wherein the door operation mechanism comprises at least one of a pulley, a mechanical arm, a keypad, a door handle, and a door hinge.

8. The door operation method of claim 7, wherein the door handle is a round handle, an up/down lever, or controls a magnetic mechanism.

9. A door operation apparatus for a portable module for operating a door, comprising:
a sensing module of the door operation apparatus for determining a request to at least one of open or close the door;
a door operating processor of the door operation apparatus for handling the determined request to the at least one of opening or the closing of the door based on the sensing;
a door operating mechanism of the door operation apparatus for engaging a door to at least one of open or close; and
a door latching mechanism of the door operation apparatus for coupling the portable module apparatus to the door.

10. The door operating apparatus of claim 9, the sensing module further for at least one of:
sensing that at least one object passed through the door and closing the door after such sensing;
recognizing a physical feature and at least one of closing or opening the door;
sensing an area is clear of obstacles and closing the door;
reaching a time threshold and closing the door due to the time threshold;
sensing at least one of a decrease or increase in weight on an area and at least one of closing or opening the door accordingly, respectively;
sensing a sound requesting at least one of closing or opening of the door and at least one of closing or opening the door accordingly, respectively;
sensing motion for at least one of opening or closing the door;
receiving data instructing for at least one of closing or opening of the door, and at least one of closing or opening the door accordingly, respectively, wherein the data is received via at least one of a wireless and wired connection, and wherein the data instruction is from at least one of a magnetic card, a keyless entry, a keypad, an application on a portable device, a device on a handicap equipment, oxygen tank, patient IV device, stroller, a device on a hospital equipment, wheel chair, a wearable device, a portable device and data over at least one WIFI, BlueTooth, New Field Communication, Internet, IP connectivity, fiber optics, radio frequency, multi-drop surface, and satellite modem.

11. The door operation apparatus of claim 9, wherein the portable module is coupled to a pre-exiting door, without the need for a custom door.

12. The door operation apparatus of claim 11, wherein the portable module is coupled to at least one of a handle of the door, one or more hinge of the door, a surface adjacent to the door, and on the door itself.

13. The door operation apparatus of claim 12, wherein the hinges are position on at least one of the side of the door, top of the door of the bottom of the door.

14. The door operation apparatus of claim 9, wherein the door is at least one manual door, electric, door, French door, swinging door, or roll up/down door.

15. The door operation apparatus of claim 9, wherein the door operation mechanism comprises at least one of a pulley, a mechanical arm, a keypad, a door handle, and a door hinge.

16. The door operation apparatus of claim 15, wherein the door handle is a round handle, an up/down lever, or controls a magnetic mechanism.

17. A door operation system comprising a door and a door operating apparatus for a portable module for operating the door, the door operating apparatus comprising:
a sensing module of the door operation apparatus for determining a request to at least one of open or close the door;
a door operating processor of the door operation apparatus for handling the determined request to the at least one of opening or the closing of the door based on the sensing;
a door operating mechanism of the door operation apparatus for engaging a door to at least one of open or close; and
a door latching mechanism of the door operation apparatus for coupling the portable module apparatus to the door.

18. The door operating system of claim 17, the sensing module further for at least one of:
sensing that at least one object passed through the door and closing the door after such sensing;
sensing an area is clear of obstacles and closing the door;
reaching a time threshold and closing the door due to the time threshold;
sensing at least one of a decrease or increase in weight on an area and at least one of closing or opening the door accordingly, respectively;
recognizing a physical feature and at least one of closing or opening the door;
sensing a sound requesting at least one of closing or opening of the door and at least one of closing or opening the door accordingly, respectively;
sensing motion for at least one of opening or closing the door;
receiving data instructing for at least one of closing or opening of the door, and at least one of closing or opening the door accordingly, respectively, wherein the data is received via at least one of a wireless and wired connection, and wherein the data instruction is from at least one of a magnetic card, a keyless entry, a keypad, an application on a portable device, a device on a handicap equipment, oxygen tank, patient IV device, stroller, a device on a hospital equipment, wheel chair, a wearable device, a portable device and data over at least one WIFI, BlueTooth, New Field Communication, Internet, IP connectivity, fiber optics, radio frequency, multi-drop surface, and satellite modem.

19. The door operation system of claim 17, wherein the portable module is coupled to a pre-exiting door, without the need for a custom door.

20. The door operation system of claim 19, wherein the portable module is coupled to at least one of a handle of the door, one or more hinge of the door, a surface adjacent to the door, and on the door itself.

21. The door operation system of claim 20, wherein the hinges are position on at least one of the side of the door, top of the door of the bottom of the door.

22. The door operation system of claim 17, wherein the door is at least one manual door, electric, door, French door, swinging door, or roll up/down door.

23. The door operation system of claim 17, wherein the door operation mechanism comprises at least one of a pulley, a mechanical arm, a keypad, a door handle, and a door hinge.

24. The door operation system of claim 23, wherein the door handle is a round handle, an up/down lever, or controls a magnetic mechanism.
